(19) United States
(12) Patent Application Publication
(10) Pub. No.: US 2020/0183121 A1
(43) Pub. Date: Jun. 11, 2020

(54) Camera System

(71) Applicant: Makoto TAKAMIYA, Tokyo (JP)

(72) Inventor: Makoto TAKAMIYA, Tokyo (JP)

(21) Appl. No.: 16/303,652

(22) PCT Filed: May 9, 2017
(86) PCT No.: PCT/JP2017/017567

§ 371 Date: Nov. 20, 2018

(30) Foreign Application Priority Data
May 20, 2016 (JP) 2016-101571

(51) Int. Cl. G02B 7/04; G03B 15/00; G03B 35/08

(52) U.S. Cl. CPC G02B 7/04; G03B 35/08; G03B 15/006

(57) ABSTRACT

The purpose of the present invention is to provide a camera system that acquires entertaining three-dimensional images and to provide a controller of the camera system. In the present invention relates to the camera system, there are two cameras, and a control means for varying the camera distance Dc [m] between the two camera units, each camera has a zoom lens. And the focal length (f1, f2) of the zoom lens of the two cameras between the two camera units is interlocked with the camera distance Dc [m].

### DETAILED DESCRIPTION OF THE INVENTION

### Technical Field

The present invention relates to a camera system for acquiring a stereoscopic image.

### Background Art

As a technique of this type, Patent Document 1 makes it possible to adjust the position of the image sensor and synthesize images. The position can be finely adjusted flexibly when it is used.

### PRIOR ART DOCUMENT

### Patent Document

[Patent Document 1] Japanese Patent Application Publication No. 2013-59026

### SUMMARY OF THE INVENTION

### Disclosure of the Invention

However, in Patent Document 1, the object is to acquire a three-dimensional image perceived by a person, and no mention is made of three-dimensional image acquisition that considers entertainment. The purpose of the present invention is to provide a camera system that acquires entertaining three-dimensional images and to provide a controller of the camera system.

### SUMMARY OF THE INVENTION

In the present invention relates to the camera system, there are two cameras, each camera has a zoom lens, and the focal length of the zoom lens of the two cameras (f1, f2) is interlocked with the distance Dc [m] between the two camera units.

A first aspect of the present invention relates to a camera system.

This system is a camera system having two camera units 21A and 21B. Each of two camera units 21A and 21B has each an optical system included the zoom lens 22A, 22B. The camera system has means for varying the camera distance Dc between the two camera units, the focal lengths (f1, f2) of the zoom lenses of the two camera units, and has control means for controlling the optical systems of the two camera units to be moved so as to be interlocked with the camera distance Dc between the two camera units.

Since the zoom lens focal length (f1, f2) changes in conjunction with the camera distance Dc, this system can change the camera angle of view (lens magnification) and the parallax image interval continuously and smoothly.

A preferred embodiment of this camera system is that the two camera units 21A and 21B have the same characteristic zoom lenses 22A and 22B, and have the same sensors 23A, 23B with the same sensor size, the number of sensor pixels. Then, the camera system controls the optical system of the camera unit, and the control means controls the focal lengths (f1, f2: the same value f [mm]) of the two zoom lenses to maintain the relationship below, with respect to the distance Dc between the two camera units.

f[mm]=a*Dc[m]+b[mm] (a, b: constant) Formula (I)

(In the formula (I), f [mm] is 6 or more and 1200 or less, a is 10 or more and 200 or less, B is 0 or more and 600 or less.)

Because this camera system has the camera units 21A and 21B with the same characteristic zoom lens 22A, 22B, and the sensors 23A and 23B having the same sensor size, and the same number of sensor pixels, if we watch each of the obtained two images by each eye of the left and right, there is an advantage that natural stereoscopic images.

f[mm]=a*Dc[m]+b[mm] (a, b: constant) Formula (I)

(In the formula (I), f [mm] is 6 or more and 1200 or less, a is 10 or more and 200 or less, B is 0 or more and 600 or less.)

Also, because this camera system controls the optical system of the camera unit so as to maintain the above relationship, there are advantages that it keeps down feeling discomfort of viewing while experiencing the difference with the usual feeling when viewing it, and that it realizes the optical configurations acceptable to perceive for stereoscopic viewing.

In a preferred embodiment of this camera system, it has the means for varying the distance Dc [m] between the two camera units respectively in conjunction with the height h [m] which two camera units 21A and 21B positioned. Interlocking the camera height h and the camera unit distance Dc [m] and the focal lengths of the zoom lens, the optical system of the camera system can acquire images of the left and right eyes as if the human body is large (or small).

In a preferred embodiment of this camera system, the means of varying the distance Dc [m] maintains the relationship of the formula (II) with respect to the height h (=h1=h2) [m] which the two camera units 21A and 21B are positioned.

Dc[m]=c*h[m]+d[m] (c, d: constant) Formula (II)

(In the formula (II), Dc [m] is 0 or more and 100 or less, c is 0.01 or more and 5 or less And d is 0 or more and 100 or less.)

By controlling in this manner, there are advantages that it is possible to obtain an optical configuration which can be sensuously tolerated by a person in stereoscopic viewing, at the same time that it suppresses discomfort of feeling as much as possible, and that it can be realized to acquire 2 images as if a person reproduces the image when viewing as it gradually becomes bigger, while experiencing the difference from the usual sense.

In a preferred embodiment of this camera system, the height control means maintains the relationship of the formula (II), the formula (III), with respect to the height h (=h1=h2) [m] of the two camera units 21 and the distance Dc [m] between two camera units.

Dc[m]=c*h[m]+d[m] (c, d: constant) Formula (II)

f[mm]=i*h[m]+j[mm] (i, j: constant) Formula (III)

(i=a*c, j=a*d+b)

By controlling in this manner, there are advantages that it is possible to obtain an optical configuration which can be sensuously tolerated by a person in stereoscopic viewing, at the same time that it suppresses discomfort of feeling as much as possible, and that it can be realized to acquire 2 images as if a person reproduces the image when viewing as it gradually becomes bigger, while experiencing the difference from the usual sense.

A preferred embodiment of this camera system further comprises a first controller 33 settable constant a and b. Since it has such a controller, it is possible for the user to set up the difference with the usual sense when viewing according to his/her preference. There is an advantage that a stereoscopic image peculiar to the user can be created.

A preferred embodiment of the camera system comprises a second controller 70 capable of setting one or both of them ((1) the constant c and d, (2) the constant i and j). By such a controller, there is an advantage that a stereoscopic image peculiar to the user can be created, so that the user sets the difference from the usual feeling at the time of viewing according to his/her preference.

A preferred embodiment of this camera system comprises a third controller (33, 70). Since it has such a controller, it is possible for the user to set up the difference with the usual sense when viewing according to his/her preference. There is an advantage that a stereoscopic image peculiar to the user can be created.

A preferred embodiment of this camera system further comprises one flying object 40, and the two camera units 21A and 21B are attached to one flying object 40. Since it has such a configuration, there is an advantage that the positional freedom of the image subject and the camera system is high in order to eliminate the physical restrictions on height and position control.

A preferred embodiment of this camera system further comprises two flying objects 90A, 90B, and the two camera units 21A, 21B each have two flying objects 90A, 90B, respectively. Since it has such a configuration, there is an advantage that the positional freedom of the image subject and the camera system is high in order to eliminate the physical restrictions on height and position control.

### Effect of the Invention

According to the present invention, since the zoom lens focal lengths (f1, f2) are set with respect to the camera distance Dc, the camera angle of view (lens magnification) and the interval between the parallax images can be changed continuously. In particular, by interlocking the camera height h, the camera distance Dc [m] between the camera units and the focal length of the zoom lens, the optical system of the camera system is possible to acquire two images of the left and right eyes when the human body becomes bigger (or smaller). Therefore, by observing the resulting image, to experience the 3D image not unnatural can be achieved.

Normally, the human eye has the same focal length for the right eye and the left eye, but in reality the focal length for the right eye and the left eye are a little bit different. Though the focal length is slightly different, we can see two images of both eyes as almost the same, because we can correct well with the brain.

Therefore, it is ideal that the same focal length f interlocks with the interval Dc of the camera unit. However, as long as it is somewhat different focal lengths f1 and f2, it is no problem.

### BRIEF DESCRIPTION OF THE DRAWINGS

FIG. 1 an overall system configuration diagram of a first embodiment of the present invention

FIG. 2 a view for explaining a Slide structure 26 of a first embodiment of the present invention

FIG. 3 a view illustrating a monitor unit 31 according to a first embodiment of the present invention

FIG. 4 a view for explaining modes in the monitor unit 31

FIG. 5 a view for explaining the relationship between the drive controller 33 in the monitor unit 31 and an image

FIG. 6 a view for explaining the relationship between the camera distance and the zoom lens focal length

FIG. 7 a view for explaining an image recorded on a recording media

FIG. 8 a view for explaining a configuration of a human eye

FIG. 9 a view in the case where the eye configuration when a person become huge is replaced with a camera configuration

FIG. 10 a view for explaining a camera configuration which becomes magnification equivalent to FIG. 8 when a person become huge

FIG. 11 a view for explaining a configuration for increasing a magnification when a person become huge

FIG. 12 an overall system configuration diagram of a second embodiment of the present invention

FIG. 13 a view showing the relationship between the camera distance Dc and the height h of the two eye camera system 20 of the second embodiment of the present invention

FIG. 14 a configuration diagram of the drone controller 60 and the monitor unit 31

FIG. 15 a view showing a setting screen for the height interlocking mode according to the second embodiment of the present invention

FIG. 16 an overall system configuration diagram of the third embodiment of the present invention

FIG. 17 an diagram of a two eye camera system 50 according to a third embodiment of the present invention

FIG. 18 a view showing the relationship between the camera distance Dc and the height h of the two eye camera system 20 of the third embodiment of the present invention

FIG. 19 a view showing a setting screen for the height interlocking mode according to the third embodiment of the present invention

FIG. 20 a view for explaining a simulated experience when a person become a giant

### DETAILED DESCRIPTION OF THE INVENTION

A first aspect of the present invention relates to a camera system.

This system is a camera system having two camera units 21A and 21B. The two camera units 21A and 21B include zoom lenses 22A and 22B. In addition to the zoom lens, this optical system has a known structure possessed by the optical system of the camera can be appropriately adopted. Therefore, the two camera units 21A and 21B are possible to adjust the focal length. Elements for adjusting the focal length are known. For example, the focal length can be adjusted by moving the zoom lens in the optical axis direction. That is, the camera system can move the zoom lens as one element of the optical system as long as it has a means (eg, actuator) that can be used. Receiving a command from the control unit to activate the actuator, the position of the zoom lens is adjusted and the focal length is adjusted.

The camera system has means for varying the distance Dc between the two camera units. When two camera units are connected by an actuator etc., the distance between the two camera units can be controlled by the control unit to activate the actuator so that. On the other hand, when two camera units are mounted on different ones (for example, the first camera unit is mounted on the first drone and the second camera unit is mounted on the second drone), using GPS (for example), the two position of the object to be mounted may be controlled while measuring the position and distance of the camera units. Also, one of the two camera units has an observation part for observing the other position, while measuring the distance Dc between the two camera units, using the observation information of the two camera units. So, by changing the position of the camera unit, the distance Dc between the two camera units may be varied.

The control means controls the zoom lens focal length (f1, f2) of each of the two camera units in conjunction with the distance Dc between the two camera units. When the control means is connected to the two camera units by wire, the user inputs information on the distance Dc between the two camera units in the system. Then, on the basis of the information on the input Dc, the control means adjusts the distance Dc between camera units. On the other hand, the control means controls the zooming corresponding to the distance Dc. Since the focal length is read out from the storage unit or calculated by the calculation unit, the optical system of the camera unit is controlled based on the focal length (f1, f2) obtained. Specifically, the two camera units are designed to be able to adjust the distance between the lens and the image sensor, and the distance between the lens and the image sensor may be adjusted according to the control signal from the control unit. If the two camera units are mounted on the flying object, the control means transmits a radio signal to the flying object, the receiving unit of the flight object receives the control signal, and according to the received control signal, the control means adjusts the optical system, and adjusts the focal length. In this case, for example, the actuator can adjust the distance between the lens and the image sensor.

Since the zoom lens focal lengths (f1, f2) are set with respect to the camera unit distance Dc in this system and the magnification is changed, the camera angle (lens magnification) and the spacing of the parallax image can be changed continuous and smoothly.

A preferred embodiment of this camera system is that the two camera units 21A have the same characteristic zoom lenses 22A and 22B and the same sensors 23A, 23B with the same sensor size, the number of sensor pixels. When two camera units have the same characteristic of the lens and the image sensor, it is easy to adjust the focal length. In this embodiment, the camera system controls the optical system of the camera unit, and the control means controls the focal lengths (f1, f2: the same value f [mm]) of the two zoom lenses to maintain the relationship below, with respect to the distance Dc between the two camera units.

f[mm]=a*Dc[m]+b[mm] (a, b: constant) Formula (I)

(In the formula (I), f [mm] is 6 or more and 1200 or less, a is 10 or more and 200 or less, b is 0 or more and 600 or less.)

f [mm] may be 10 or more and 1000 or less, may be 15 or more and 500 or less, or 200 r more and 300 or less.

The constant a may be 15 or more and 150 or less, may be 20 or more and 100 or less, or may be 25 or more and 70 or less.

The constant b may be 0 or more and 400 or less, may be 1 or more and 300 or less, or 2 or more and 200 or more Or less.

In this camera system, the camera units 21A and 21B have the same characteristic zoom lens 22A, 22B, and the sensors 23A and 23B having the same sensor size and the same number of sensor pixels Therefore, when viewing the two images obtained with the left and right eyes it is possible to see with almost the same image quality. So, there is an advantage that natural stereoscopic images without feeling of incompatibility can be appreciated.

f[mm]=a*Dc[m]+b[mm] (a, b: constant) Formula (I)

(In the formula (I), f [mm] is 6 or more and 1200 or less, a is 10 or more and 200 or less, b is 0 or more and 600 or less.)

Also, because this camera system controls the optical system of the camera unit so as to maintain the above relationship, there are advantages that it keeps down feeling discomfort of viewing while experiencing the difference with the usual feeling when viewing it, and that it realizes the optical configurations acceptable to perceive for stereoscopic viewing.

In the case of having an actuator as one element of the optical system, the camera system can move the zoom lens by the actuator driven in response to a command from the control unit, and the focal length can be adjusted by moving the lens.

In a preferred embodiment of this camera system, two camera units 21A and 21B are positioned the means for varying the distance Dc [m] between the two camera units in conjunction with the height h [m] respectively. In the camera system of this embodiment, for example, since the two camera units are equipped with GPS, GPS can grasp the height of the camera unit. When two each camera unit is mounted on two each flying object, each flying object may have a GPS. In this case, the height of one of the flying objects is defined as the height h [m] alternatively, the average of the heights of the two flying objects may be h [m]. Also, two flight objects may be controlled to be about the same. Since the camera height h and camera unit distance Dc [m] and the focal length of the zoom lens are interlocked, the optical system of the camera system can obtain the two images of the left and right eyes when the human body gets bigger (or smaller). The methods for controlling the height of the aircraft are known, and the camera system may control the flying object to be a predetermined height by steering the flying object while measuring the height of the flying object.

In a preferred embodiment of this camera system, the means of varying the distance Dc [m] maintains the relationship of the formula (II) with respect to the height h (=h1=h2) [m] which the two camera units 21A and 21B are positioned.

Dc[m]=c*h[m]+d[m] (c, d: constant) Formula (II)

(In the formula (II), Dc [m] is 0 or more and 100 or less, c is 0.01 or more and 5 or less and d is 0 or more and 100 or less.)

When two camera units are mounted on separate items, Dc [m] is 0.1 or more and 100 or less, and may be 0.2 or more and 50 or less, or may be 0.2 or more and 20 or less. In the case where two camera units are mounted on a single items, since increasing Dc [m] is difficult, Dc [m] may be, for example, 0 or more and 1 or less, or 0 or more It may be 0.5 or less, or may be 0 or more and 0.3 or less.

The constant c may be 0.05 or more and 4 or less, or may be 0.1 or more and 3 or less. The constant d may be 0 to 80, 1 to 70, or 2 to 50.

By controlling in this manner, there are advantages that it is possible to obtain an optical configuration which can be sensuously tolerated by a person in stereoscopic viewing, at the same time that it suppresses discomfort of feeling as much as possible, and that it can be realized to acquire 2 images as if a person reproduces the image when viewing as it gradually becomes bigger, while experiencing the difference from the usual sense.

In a preferred embodiment of this camera system, the height control means maintains the relationship of the formula (II), the formula (III), with respect to the height h (=h1=h2) [m] of the two camera units 21 and the distance Dc [m] between two camera units.

Dc[m]=c*h[m]+d[m] (c, d: constant) Formula (II)

f[mm]=i*h[m]+j[mm] (i, j: constant) Formula (III)

(i=a*c, j=a*d+b)

By controlling in this manner, there are advantages that it is possible to obtain an optical configuration which can be sensuously tolerated by a person in stereoscopic viewing, at the same time that it suppresses discomfort of feeling as much as possible, and that it can be realized to acquire 2 images as if a person reproduces the image when viewing as it gradually becomes bigger, while experiencing the difference from the usual sense.

A preferred embodiment of this camera system further comprises a first controller 33 settable constant a and b. Since it has such a controller, it is possible for the user to set up the difference with the usual sense when viewing according to his/her preference. There is an advantage that a stereoscopic image peculiar to the user can be created. This controller is made possible to give and receive the information from the storage, if the constants a and b is input in the controller, the control unit stores the values of the constants a and b in a predetermined area of the storage unit. In addition, the control unit reads out the values of the input constants a and b, and the other values which is necessary for calculation, and the calculation unit is caused to perform predetermined calculation. In this way, the focal length f, the value of the distance Dc can be obtained, and the value can be used to control the camera system.

A preferred embodiment of the camera system comprises a second controller 70 capable of setting one or both of them ((1) the constant c and d, (2) the constant i and j). For example, if this controller is able to set the constants c and d (or i and j) can be set, the user may adjust only the constant c. Further, the controller 70 is the same as the first controller 33 described above one device may be used. The first controller 33 may have the function of the second controller. Since it has such a controller, it is possible for the user to set up the difference with the usual sense when viewing according to his/her preference. There is an advantage that a stereoscopic image peculiar to the user can be created. This controller is made possible to give and receive the information from the storage, if the constants c, d, i and j is input in the controller, the control unit stores the values of the constants in a predetermined area of the storage unit. In addition, the control unit reads out the values of the input constants c, d, i and j, and the other values which is necessary for calculation, and the calculation unit is caused to perform predetermined calculation. In this way, the focal length f, the value of the distance Dc can be obtained, and the value can be used to control the camera system.

A preferred embodiment of this camera system comprises a third controller (33, 70). Since it has such a controller, it is possible for the user to set up the difference with the usual sense when viewing according to his/her preference. There is an advantage that a stereoscopic image peculiar to the user can be created. The third controller may be the same device as the first controller or the second controller. When the third controller (33, 70) sets the distance Dc, the value of the distance Dc is input to the camera system. Then, the control unit controls the actuator based on the input distance Dc or adjusts the position of the camera unit while measuring the distance by confirming the position of the camera unit by using GPS and adjusting the position of the camera unit. Thus the control unit controls so as to approach the value of the input distance Dc.

A preferred embodiment of this camera system further comprises one flying object 40, and the two camera units 21A and 21B are attached to one flying object 40. Since it has such a configuration, there is an advantage that the positional freedom of the image subject and the camera system is high in order to eliminate the physical restrictions on height and position control. Examples of the flying body 40 are an airplane, a helicopter, a model plane, a model helicopter, and a drone. These include, for example, a radio reception unit receiving a radio signal from the controller, and it is possible to change the position of the body according to the radio signal received by the radio reception unit. Further, according to the wireless signal radio receiving unit receives, and controls various elements of the body, capture and storage, the recorded images (or recorded voice) predetermined section, It can also wirelessly transmit.

A preferred embodiment of this camera system further comprises two flying objects 90A, 90B, and the two camera units 21A, 21B each have two flying objects 90A, 90B, respectively. Since it has such a configuration, there is an advantage that the positional freedom of the image subject and the camera system is high in order to eliminate the physical restrictions on height and position control.

### Embodiment 1

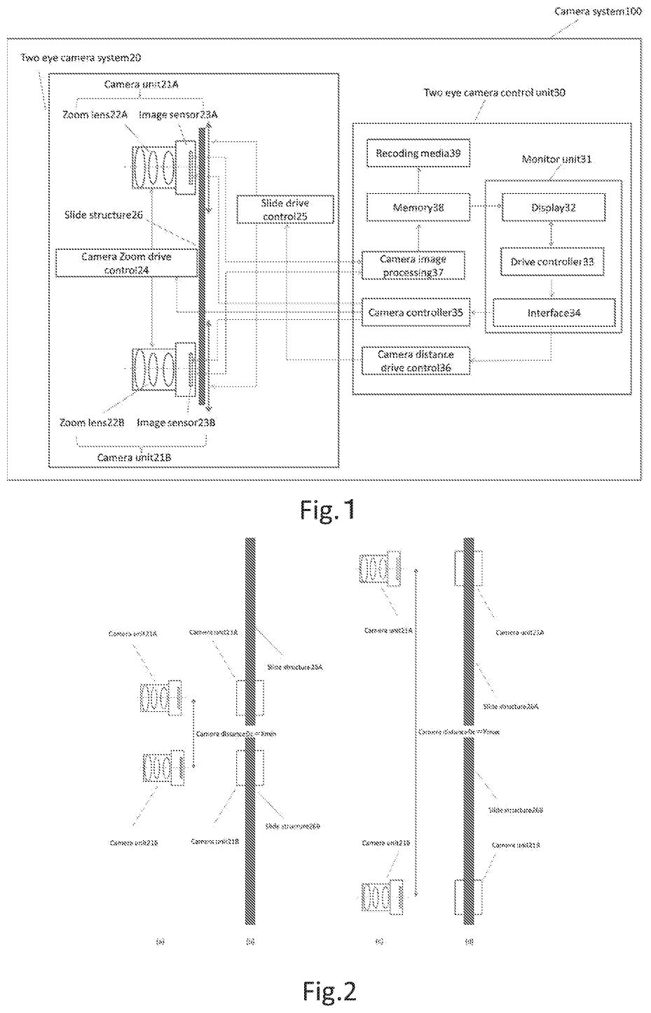

First, with reference to FIG. 1, the structure of the camera system 100 of this embodiment will be described. As FIG. 1 shown, the camera system 100 includes a two eye camera system 20, a two eye camera control unit 30. The two eye camera system 20 further includes a pair of camera unit and slide structure 26, is constituted so as to be able to control the focal length of the zoom lens of the pair of camera units 21 and the camera distance by the camera zoom drive control 24 and the slide drive control 25. The camera unit 20 includes a zoom lens 22, the image sensor 23, and makes for a proper position control with the other necessary mechanical housing. On the other hand, the two eye camera control unit 30 is structed with a monitor unit 31, a camera controller 35, a camera distance drive control 36, a camera image processing 37, memory 38, recording medium 39. The monitor unit 31 mainly comprises a display 32, a drive controller 33, and an interface 34, and this portion is integrally formed.

FIG. 2 is a view for explaining the slide mechanism section 26. FIGS. 2 (a) and 2 (b) show the view from top and behind of the camera, when the distance Dc of the camera unit is X min. FIG. 2 (c), (d) show the view from top and behind of the camera, when the distance Dc of the camera unit is Xmax. The slide structure 26 is constituted by two ball screw, motor (not shown) so that the position can be controlled by the motor.

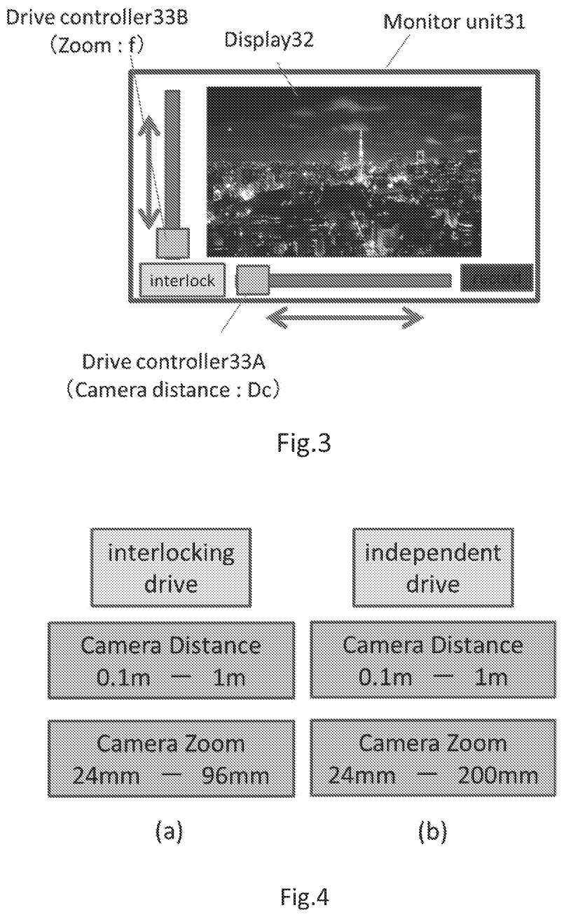

FIG. 3 is a view for explaining a monitor unit 31 of the first embodiment of the present invention. The monitor unit 31 embodies a monitor unit display 32 and a drive controller 33 for displaying the image obtained from the camera unit 21. By the drive controller 33A sliding the button in the horizontal direction, it is possible to change the camera unit distance Dc [m]. Further, by sliding the button of the drive controller 33B in the vertical direction, it is possible to change the camera zoom f [mm]. In addition, in the monitor unit 31, a selection button for interlockingly and independently switching the recording start-end button and the mode of the drive controller 33 is arranged.

FIG. 4 is a view for explaining the mode in the monitor unit 31. This is a setting screen for the mode switching described with reference to FIG. 3, and conditions can be set in advance. The mode has interlocking drive and independent drive. When being set the distance Dc [m] or the focal length f (=f1=f2) [mm] in the drive controllers 33 A and 33 B, the interlocking drive is the mode to maintain the relationship below.

f[mm]=a*Dc[m]+b[mm] (a, b: constant) (1)

When acquiring a 3D image, in order to obtain the images of the left and right eyes equivalent to the human, basically it is common to use the same optical properties, sensor characteristics. By doing so, the drive control of two optical is possible to control the control of the system in approximately the same parameters, the camera system structure becomes simpler.

The zoom lens 22 is the power zoom which can vary the zoom position by a motor, and it is possible to control to a predetermined focal length by the command transferred from the camera zoom drive control 24 for each of the two cameras.

Here, when the minimum setting value Xmin=0.1 m of the camera distance, the minimum setting value of the camera zoom (focal length) f [mm] is 24 mm, and the maximum camera setting value Xmax=1 m, the camera zoom focal point of maximum set value of the distance) f=96 mm is set. In other words, in FIG. 3, when the drive controller 33A is located the most left, the camera distance is 0.1 m and the lens focal length is 24 mm. When the drive controller 33A is located the most right, the camera distance is 1 m and the lens focal length is 96 mm. When the drive controller 33A is located the middle, in conjunction with linear expression (equation (1)), the camera distance becomes 0.5 m and the lens focal length becomes 48 mm. When sliding either of the drive controller 33A and 33B, the other drive configuration controller 33 slides.

On the other hand, in the independent drive, the respective drive controllers 33A and 33B are independently driven, and the movable range can be set by setting the maximum and minimum set values of the mode conditions in FIG. 4.

The constants a and b in the equation (1) are a=80 and b=16 respectively, respectively, the interlocking drive is the mode to maintain the relationship below.

f[mm]=80*Dc[m]+16[mm] (2)

On the other hand, in the independent drive, the respective drive controllers 33A, 33B are independently driven, and the movable range can be set by setting the maximum and minimum set values on the mode condition of FIG. 4.

Again, the flow of communicating the focal length f [mm] and the distance D [m] of zoom lens 22A, 22B will be described.

1) Set the relationship of interlocking between camera distance and focal length. (FIG. 4)
2) Set the mode to interlock drive. (FIG. 3)
3) On the preview operation, from the interface 34 of the monitor unit 31, through the controller 35, the image sensor 23A, 23B is power on, the camera image processing 37 does various image processing operations for the images obtained.
4) Transfer the image to be displayed as Live View among the obtained images to the display 32 via the memory 38, so that the image can be confirmed by the monitor unit 31. When recording button is pressed, the camera image processing 37 generates the recording images and stores the image data in the recording medium 39 through the memory 38.
5) Slide with either slider of drive controller 33A or 33B. For example, gradually slide the camera distance 0.1 m→1 m. In doing so, from the interface 34 of monitor unit 31, through the camera controller 35, the camera zoom drive control 24 changes the focal length f. In this case the drive controller 33 changes the focal length f with the relationship of equation (2) set according to the drive controller 33 position at flow 1).
6) At the same time, from the interface 34 of the monitor unit 31, through the camera distance drive control 36, the slide drive control 25 changes the distance Dc [m] which is set according to the drive controller 33 position at flow 1).

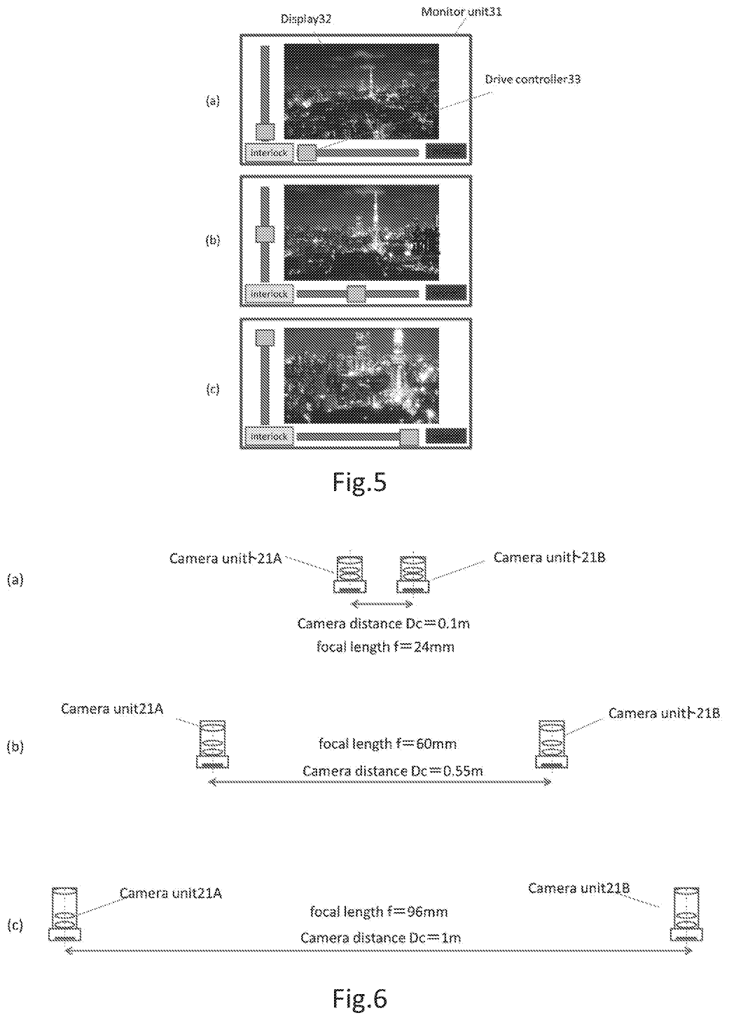

FIG. 5 is a view for explaining a relationship between the image and the drive controller 33 of the monitor unit 31, FIG. 5 (a), (b), (c) shows the acquired images at each the minimum, the intermediate, the maximum during interlocking drive of the drive controller 33.

As mentioned in 1) to 6), by either slider (the drive controller 33A or 33B) sliding, the other slider automatically slide, as a result the camera unit distance Dc and the camera focal length f are changed in conjunction with each other.

FIG. 6 (a), (b), (c) shows the relationship between camera unit distance Dc [m] and the zoom lens focal length f at each the minimum, the intermediate, the maximum during interlocking drive of the drive controller 33.

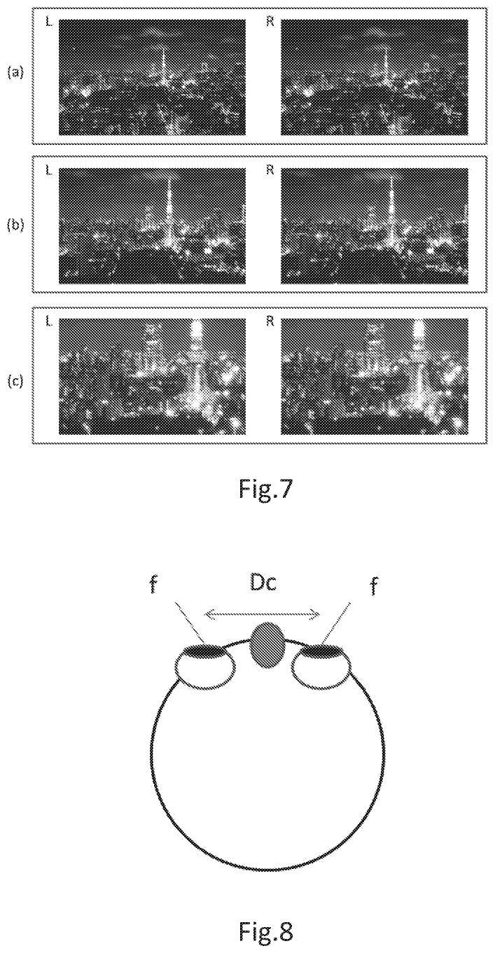

FIG. 7 is a view for explaining picture image recorded on the recording medium. FIG. 7 (a), (b), (c) show the pair image for the left and the right eye to be required stereoscopic image, which are recorded on the recording medium 39 in the three states of the optical system. And the three states of FIG. 7 (a), (b), (c) are correspond to three states of the drive controller 33 in FIG. 5 (a), (b), (c), and FIG. 6 (a), (b), (c).

(In this case, presented as still images)

By watching the recorded image with a not-shown three-dimensional television, 3D movie system or 3D goggle, it is possible to view the stereoscopic image.

Here, we consider the optical system of the human eye.

FIG. 8 is a view for explaining the configuration of the human eye. It is said that the distance between people's eyes is about 60 mm and the focal length is equivalent to the diaphragm value Fno1.8 of a super wide-angle lens with a focal length of 12 mm in terms of 35 mm full frame. The aperture values Fno is to open or close the pupil also the human eye with respect to brightness, the same kind of adjust control as the general of the camera is being carried out.

Assuming that constituted by a digital camera as the same configuration of FIG. 8, and we assume if a person becomes huge like as the Ultraman.

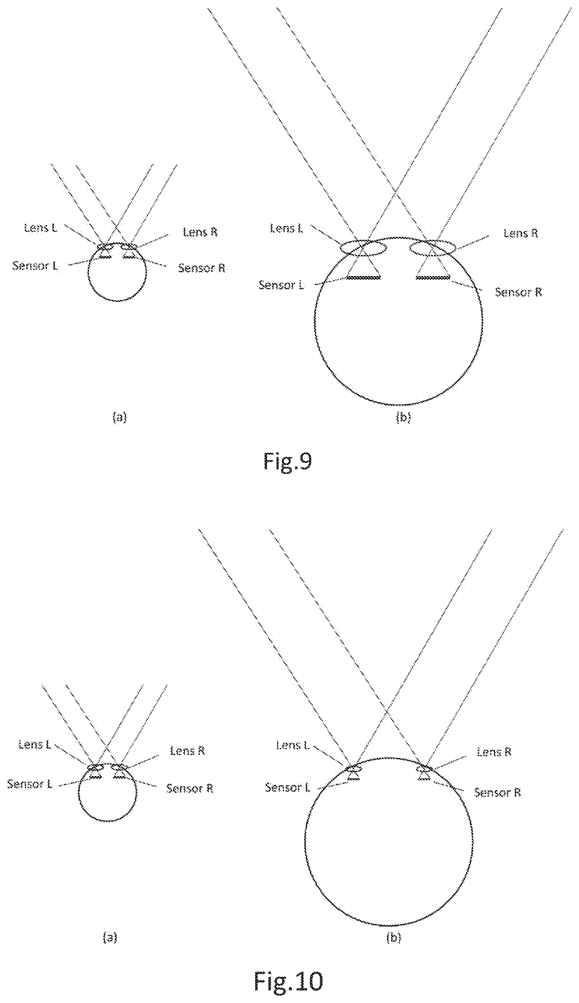

FIG. 9 is a view in the case where the configuration of the eye when the person is supposed to be enlarged is replaced by the digital camera configuration. FIG. 9 (a) shows the state of the optical system in human size, and it is composed of Lens L, R and Sensor L, R. At this time, when the person becomes huge, each constituent enzyme becomes proportionally large as shown in FIG. 9 (b). In FIG. 9 (b), the optical system is proportionally enlarged. The lens of FIG. 9 (a) has a focal length of 12 mm in terms of 35 mm full frame, the lens of FIG. 9 (b) also has a focal length of 12 mm in terms of 35 mm full frame. The lens remains as it is, and the difference in the obtained image is mainly the difference of the distance between the left and right images.

Based on the above, it can be said that it is possible to realize the configuration shown in FIG. 10 in which the configuration of the eyes when the person assumes enormous has been replaced with the digital camera configuration.

FIG. 10 is a view for explaining a camera configuration which becomes magnification equivalent to FIG. 9, when a person is giant.

If we think of it as a giant's feelings here, it seems that if you are a small person in the body you can see the nearby objects finely and the far objects look small, but if we are a giant, we must want to see the far object finely corresponding to the size of the body. So I assume an optical system that we want to request when we became huge people.

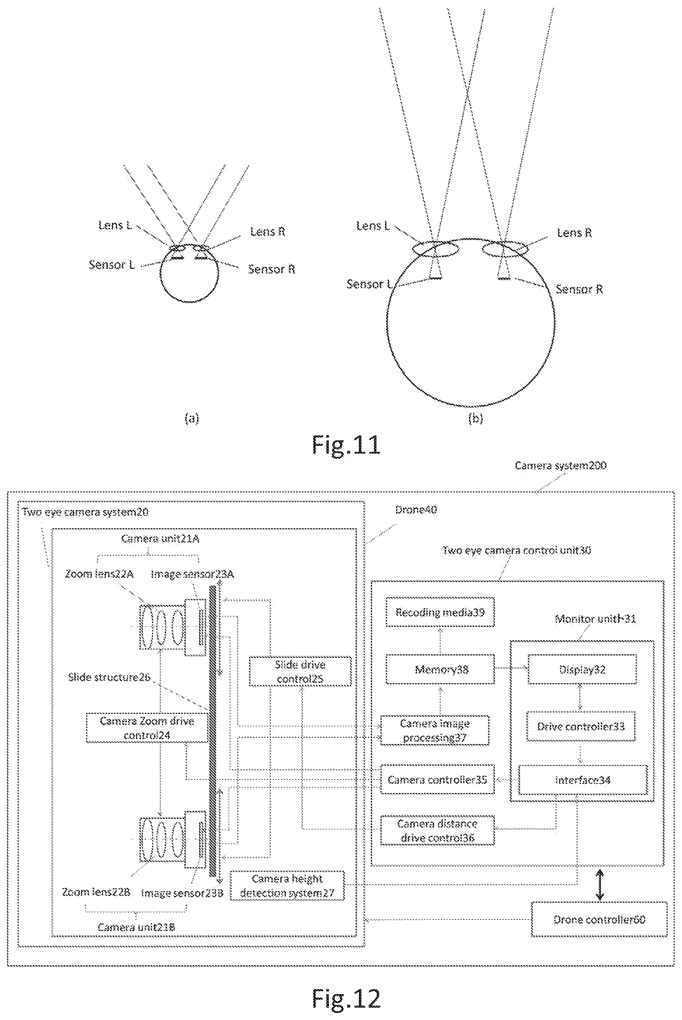

FIG. 11 is a view for explaining a configuration for increasing the magnification when a person gets enlarged.

With such a configuration, the magnification will be high, so that visibility of far objects will also increase for the far object, so that a sense of perspective appropriate for the giant should be obtained. In other words, giant eye, rather than the optical system as it is proportionally expanded human, giant was seen in conjunction with the difference, it should become more visibility is good configuration to increase to some extent magnification. It was however, if we raise the magnification too much, we will lose the wide angle that the human eye has, so we should be able to choose the balance setting taking into consideration the balance between magnification and wide angle.

Based on the above-described viewpoints, this embodiment proposes a configuration that embodies a camera system that can simulate the giant's eye in a pseudo manner.

### Embodiment 2

FIG. 12 is an overall system configuration diagram of the second embodiment of the present invention.

In the second embodiment, the difference from the first embodiment is that the slide structure 26 is integrally formed with the drone 40. In the second embodiment, the camera distance drive control 36, which is a feature of the present invention, is configured to control in conjunction with the drone controller 60.

By taking the above configuration, it is possible to acquire images for obtaining three-dimensional images in various conditions including aerial space, though what was assumed terrestrial fixed in the first embodiment.

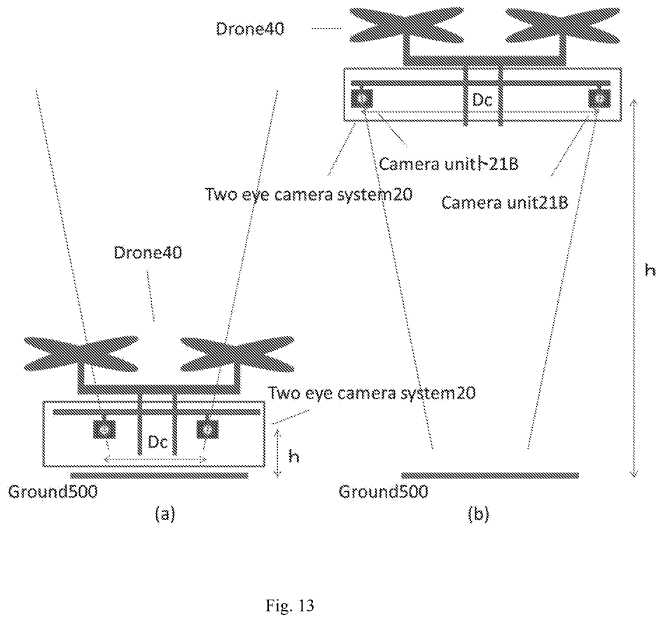

FIG. 13 is a view showing the relationship between the height h [m] of the two eye camera system 50 according to the second embodiment of the present invention and the distance Dc [m] between the camera units. For example, an image in which the state as shown in FIG. 13 (a) is changed to the state in FIG. 13 (b) in which the distance Dc [m] and the height h [m] of the camera unit changed in conjunction with each other observation makes it possible to provide a simulated experience of gradually becoming a giant thing close to the person's eye. By acquiring such an image, it is possible to experience a pseudo image as if Ultraman transforms.

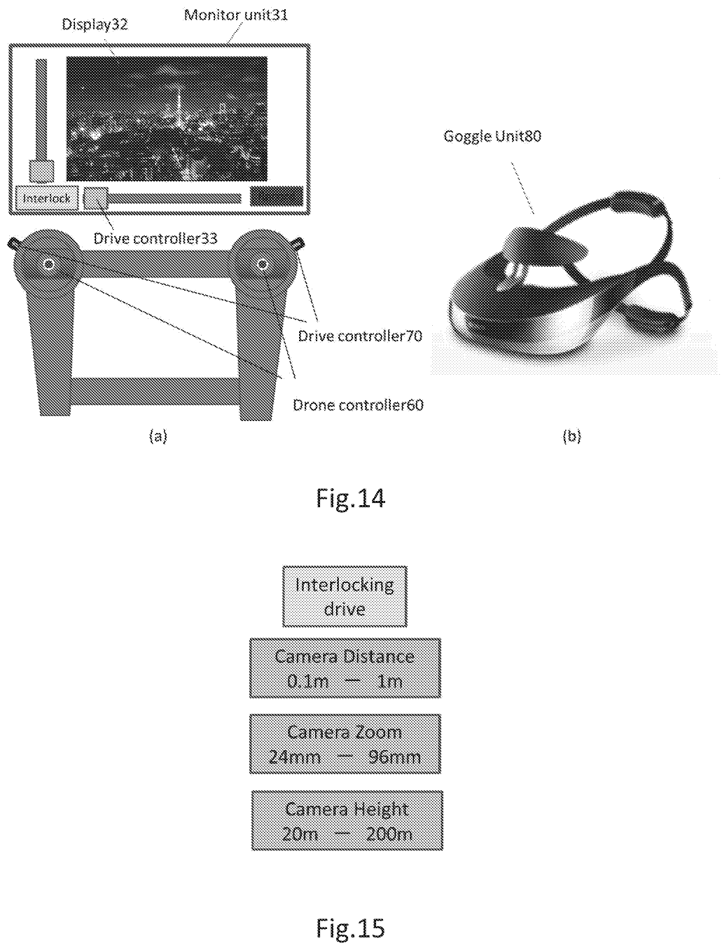

FIG. 14 is a configuration view of the drone controller 60 and the monitor unit 31. FIG. 14 (a) shows a configuration connected to the display type monitor unit 31. The drone controller 60 can be operated with the left and right fingers by the joystick type, and the drones' height, and direction can be changed. Usually, the two eye camera system 50 is steered, but the drive controller 70 is interlocked with the drive controller 33 on the display wirelessly, and not only the operation of the two eye camera system 50 but also the camera interval, the lens zoom and so on can be changed at the same time. FIG. 14 (b) shows the goggle unit 80 which is a goggle type monitor unit. In this case, a display similar to that of the monitor unit 31 shown in FIG. 14 (a) is displayed in the goggle unit 70, but images to be displayed are images different from the left and right and are recognized as three-dimensional images, it is possible to be steered.

FIG. 15 is a setting screen for the height h [m] interlocking mode, and conditions can be set in advance. It is possible to set so that the height h of the camera can be interlocked similarly to the interlocking of the camera zoom and the camera interval described in FIG. Since the camera height h can be arbitrarily changed by the drone maneuver, the camera zoom and the camera interval are linked in the camera height of 20 m-100 m shown in FIG. 15.

The constants a and b of the equation of the distance Dc [m] of the camera unit and the focal length f [mm] are a=80 and b=16 respectively as in the first embodiment,

f[mm]=80*Dc[m]+16[mm] (3)

It is designed to be linked according to the relationship.

On the other hand, the constants c and d of the equation of the distance Dc [m] and the height h of the camera unit are respectively c=0.005 and d=0,

Dc[m]=0.005*h[m] (4)

It is designed to be linked according to the relationship.

From equations (3) and (4)

f[mm]=0.4*h[m]+16 (5)

As described above, both Dc [m] and f [mm] are set in conjunction with h [m].

At a height of 20 m or less and a height of 200 m or more, the camera zoom and the camera distance are fixed to the minimum and the maximum, respectively. In this case, it is possible to automatically set the optical configuration of the two lens camera units in conjunction with the drone operation, and it is possible to acquire a pseudo image in which the human is enlarged or reduced.

A flow of interlocking the focal length f [mm] of the zoom lenses 22 A and 22 B with the camera unit interval Dc [m] and the height h [m] will be described.

1) Set the relationship of interlocking between camera distance and focal length. (FIG. 15)
2) Set the mode to interlock drive. (FIG. 14)
3) On the preview operation, from the interface 34 of the monitor unit 31, through the controller 35, the image sensor 23A, 23B is power on, the camera image processing 37 does various image processing operations for the images obtained.
4) Transfer the image to be displayed as Live View among the obtained images to the display 32 via the memory 38, so that the image can be confirmed by the monitor unit 31. When recording button is pressed, the camera image processing 37 generates the recording images and stores the image data in the recording medium 39 through the memory 38.
5) The drone camera height h [m] is arbitrarily changed by the operator's pilot.
6) The height h [m] of the two eye camera system 50 is determined by an ultrasonic distance sensor (not shown), which is a camera height detection system 27 mounted on the drone 40, to an accurate height h [m] from the ground is detected.
7) The information of the detected camera height h [m] is transmitted to the interface 34 of the monitor unit 31. And the camera distance drive control 36 maintains the camera distance Dc [m] of the interlocking relation of the equation (4).
8) Simultaneously, from the interface 34 of the monitor unit 31, through the camera controller 35, the camera zoom lens drive control 24 changes the focal length f interlocked with the camera distance Dc [m] (camera height h [m]), on the based on the equation (3), (5).

By performing the above sequence, the camera height h [m], the camera unit distance Dc [m], and the focal length f [mm] can be operated in conjunction with each other.

### Embodiment 3

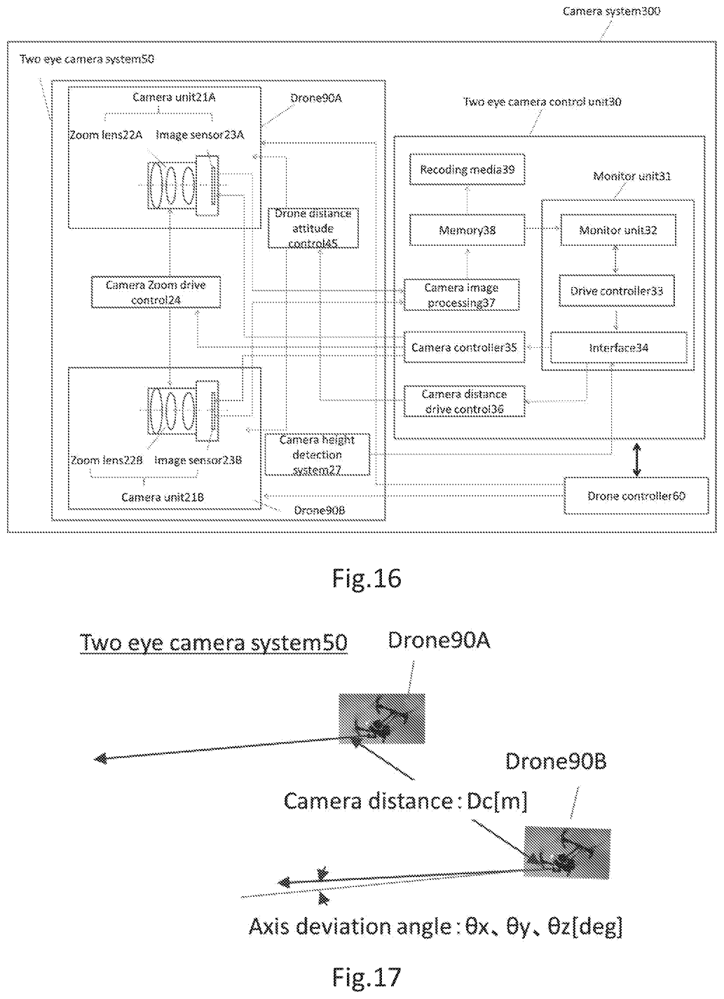

FIG. 16 is an overall system configuration diagram of the third embodiment of the present invention.

In the third embodiment, the difference between this embodiment 2, camera unit 21 instead of the slide mechanism portion 26 is a point which is constituted by drone 90 each independently. Though the drone 90A, 90B are necessary to be controlled the various physical quantities, including the distance Dc [m] camera units each attitude control, angle control, they are automatically controlled by the drone controller 60. The camera distance drive control 36 which is a feature of the present invention, is configured to control in cooperation with the drone controller 60.

FIG. 17 is an image view of the two eye camera system 50 according to the second embodiment of the present invention. As shown in the figure, the posture misalignment between the drones 90A and 90B results in an image shift, so that it is configured to be automatically controlled so as to cancel these deviations.

By adopting the above configuration, it is possible to acquire images, and it becomes possible to acquire a three-dimensional image under various conditions including aerial space as in the second embodiment.

The configuration view of the drone controller 60 and the monitor unit 31 and the setting screen for the height h [m] interlocking mode have the same configuration as in the second embodiment.

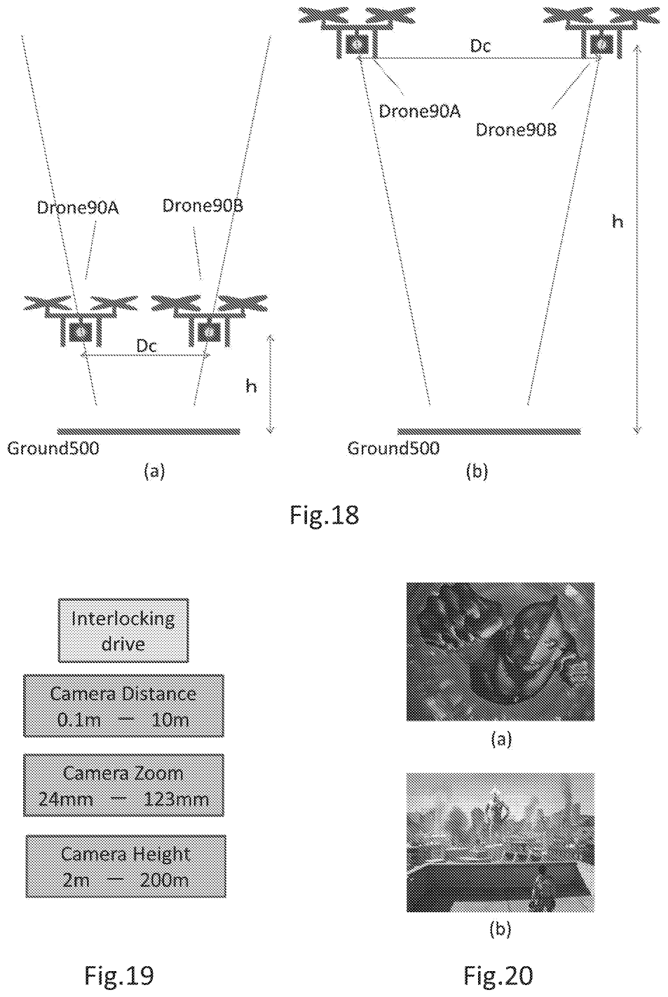

FIG. 18 is a view showing the relationship between the height h and the distance Dc [m] of the two eye camera system 50 of the third embodiment of the present invention. For example, if we watch the continuous images changed from the state of FIG. 18 (a) to the state of FIG. 18 (b), it is possible to provide a simulated experience of gradually becoming a giant. By acquiring such images, we can see the image which the Ultraman might have seen the image when he transforms to a giant.

FIG. 19 is a setting screen for the height h interlocking mode, and conditions can be set in advance. It is possible to set so that the height h of the camera can be interlocked similarly to the interlocking of the camera zoom and the camera interval described in FIG. 4. Since the pilot set the camera height h by flight of drones flexibility, the camera height (2 m-100 m) shown in FIG. 19 is possible to change while interlocking the camera zoom and camera distance.

The constants a and b of the equation of the distance Dc [m] of the camera unit and the focal length f [mm] are a=100 and b=14,

f[mm]=100*Dc[m]+14 (6)

It is designed to be linked according to the relationship.

On the other hand, the constants c and d of the equation of the interval D c and the height h [m] of the camera unit are respectively c=0.05 and d=0,

Dc[m]=0.005*h[m] (7)

It is designed to be linked according to the relationship.

From equations (6) and (7)

f[mm]=0.5*h[m]+14 (8)

At a height of 2 m or less and a height of 200 m or more, the camera zoom and the camera distance are fixed to minimum and maximum, respectively. In this case, in conjunction with the drone manipulating optical structure of 2-eye camera unit automatically it can be set, the giant is the human eye, obtaining a pseudo image such as that reduction becomes possible.

A flow of interlocking the focal length f [mm] of the zoom lenses 22A and 22B with the camera unit interval Dc [m] and the height h will be described.

1) Set the relationship of interlocking between camera distance and focal length. (FIG. 19)
2) Set the mode to interlock drive. (FIG. 14)
3) On the preview operation, from the interface 34 of the monitor unit 31, through the controller 35, the image sensor 23A, 23B is power on, the camera image processing 37 does various image processing operations for the images obtained.
4) Transfer the image to be displayed as Live View among the obtained images to the display 32 via the memory 38, so that the image can be confirmed by the monitor unit 31. When recording button is pressed, the camera image processing 37 generates the recording images and stores the image data in the recording medium 39 through the memory 38.
5) The drone camera height h [m] is arbitrarily changed by the operator's pilot.
6) The height h of two eye camera system which is a height from the respective ground hA, hB are detected by the camera height detection system that 27 by ultrasonic distance sensor (not shown) which are mounted on the drone 90A, 90B.
7) Information on the detected camera height h [m] is transmitted to the interface 34 of the monitor unit 31.
8) On the other hand, the gyro sensor (not shown) attached the drone 90A, 90B detects the angular displacement of the camera axis deviation angle θx, θy, θz [deg] in FIG. 17, so the drone distance attitude control 45 makes zero the camera axis deviation angle automatically.
9) Further, the camera distance Dc [m] between the drones is also detected by the ultrasonic distance sensor (not shown).
10) The drone distance attitude control 45 maintains the camera distance Dc of the interlocking relationship of the formula (7) through the interface 34, the camera distance drive control 36 with respect with information on the detected camera height h [m].
11) Simultaneously, from the interface 34 of the monitor unit 31, through the camera controller 35, the camera zoom lens drive control 24 changes the focal length f interlocked with the camera distance Dc [m] (camera height h [m]), on the based on the equation (6), (8).

By performing the above sequence, the camera height h [m], the camera unit distance Dc [m], and the focal length f [mm] can be operated in conjunction with each other.

In embodiment 2 and 3, the ensuring accuracy of the detection of camera height h [m] and the camera unit distance Dc[m] has shown an example of detecting the ultrasonic sensor. The ensuring accuracy of the detection may be a laser distance meter, also future GPS which the detection accuracy can be improved. The distance Dc [m] between the cameras units may be detected only by the GPS detection system used for angle detection. In addition, a detection system not shown here may be adopted for height detection and camera interval detection.

By using the camera system embodiment as described above, we can obtain an image that can virtually experience the Ultraman eyes as shown in FIG. 20, and to provide a camera system that is entertaining.

In the second and third embodiments, the configuration in which the height is interlocked by the drone configuration has been described, but the same function can be realized by providing the height drive mechanism in the first embodiment.

Further, in the present embodiment, description has been made assuming a process of becoming a giant, but it is possible to provide a different pseudo-sense even if the interlocking properties of the zoom lens and the camera interval are set to different patterns. Such an example is also included in the present invention.

### EXPLANATION OF SIGN

20, 50 Two eye camera system
21 Camera unit
22 Zoom lens
23 Image sensor
24 Camera zoom drive control
25 Slide drive control
26 Slide structure
27 Camera height detection system
30 Two eye camera control unit
31 Monitor unit
32 Display
33, 70 Drive controller
34 Interface
35 Camera controller
36 Camera distance drive control
37 Camera image processing
38 Memory
39 Recoding media
40, 90 Drone
45 Drone distance attitude control
60 Drone controller
80 Goggle Unit
100, 200, 300 Camera system
500 Ground

1. A camera system having two camera units (21A, 21B),
wherein each of the two camera units (21A, 21B) comprises an optical system including zoom lens (22A, 22B),
wherein the camera system comprises a means for varying a camera distance Dc between the two camera units,
characterized in that the camera system comprises a control means for controlling the optical system of the two camera units such that focal lengths (f1, f2) of the two camera units interlock with the camera distance Dc,
a control means for varying the camera distance Dc [m] interlocking with the height (h [m]) where the two camera units (21A, 21B) are located,
the two camera units (21A, 21B) have each the same characteristic zoom lenses (22A, 22B) and image sensors (23A, 23B) having the same sensor size and the same number of sensor pixels,
the control means controls the optical system as the two zoom lens focal lengths (f1, f2) of the same value (f [mm]) and the camera distance Dc [m] to maintain the relationship below,
f[mm]=a*Dc[m]+b[mm](a, b: constant) Formula (I)
(In the formula (I), f is 6 or more and 1200 or less, a is 10 or more and 200 or less, b is It is 0 or more and 600 or less),
the control means controls the focal lengths (f) interlocking with the camera height (h [m]) of two camera units (21A, 21B) and Dc [m] to maintain the relationship below,
Dc[m]=c*h[m]+d[m](c, d: constant) Formula (II)
(In the formula (II), Dc is 0 or more and 100 or less, c is 0.01 or more and 5 or less, d is 0 or more and 100 or less)
f[mm]=i*h[m]+j[mm](i, J: constant) Formula (III)
(In the formula (III), i=a*c, j=a*d+b).

2. (canceled)

3. (canceled)

4. (canceled)

5. (canceled)

6. The camera system according to claim 1 comprising:
furthermore, a first controller (33) capable of setting constants a and b.

7. The camera system according to claim 1 comprising:
a second controller (70) capable of setting either or both of (1) and (2)
((1) constants c and d, and (2) constants i and j).

8. The camera system according to claim 1 comprising:
a third controller (33, 70) capable of setting wherein the camera distance (Dc [m]) between the two camera units.

9. The camera system according to claim 1:
wherein the camera system further comprises the one flying object (40),
wherein the two camera units (21A, 21B) are attached to wherein the one flying object (40).

10. The camera system according to claim 1:
wherein the camera system further comprises two flying objects (90A, 90B), wherein each of the two camera units (21A, 21B) is attached to wherein each of two flying objects (90A, 90B).
